(19) United States
(12) Patent Application Publication
(10) Pub. No.: US 2023/0418016 A1
(43) Pub. Date: Dec. 28, 2023

(54) FIXING STRUCTURE AND OPTICAL DEVICE

(71) Applicant: SONY GROUP CORPORATION, TOKYO (JP)

(72) Inventors: AKIHIRO MAESAKA, TOKYO (JP); TAKUMI OKITA, TOKYO (JP)

(21) Appl. No.: 18/253,154

(22) PCT Filed: Oct. 13, 2021
(86) PCT No.: PCT/JP2021/037968

§ 371 Date: May 16, 2023

(30) Foreign Application Priority Data
Nov. 24, 2020 (JP) 2020-194725

(51) Int. Cl. G02B 7/00; G02B 7/02; G02B 1/04

(52) U.S. Cl. CPC G02B 7/003; G02B 7/025; G02B 1/04

(57) ABSTRACT

A fixing structure according to one embodiment of the present disclosure is a fixing structure including a first object and a second object that are fixed to each other with an adhesive. The first object has a first adhesive face in contact with the adhesive. The second object has a second adhesive face that faces the first adhesive face, and an extended face that is provided on at least a part of an entire periphery surrounding the adhesive about an axis perpendicular to the second adhesive face and extends in a direction parallel to the axis perpendicular to the second adhesive face. The adhesive is in contact with the second adhesive face of the second object, whereas not in contact with the extended face.

### TECHNICAL FIELD

The present disclosure relates to a fixing structure including objects that are joined with an adhesive, and an optical device including an optical component as an object to be joined.

### BACKGROUND ART

As a fixing method for an application that requires high accuracy in fixing a joint portion with an adhesive, PTL 1 discloses addition of an inorganic filler having a low thermal expansion rate to an adhesive.

### CITATION LIST

### Patent Literature

PTL 1: Japanese Unexamined Patent Application Publication No. 2003-292924

### SUMMARY OF THE INVENTION

In the technique disclosed in PTL 1, an inorganic filler having an average particle size of 1 to 20 μm is added to an adhesive to suppress a change in volume of the adhesive in a high-temperature high-humidity environment or a temperature cycle condition. However, it is difficult to completely eliminate the change in volume of the adhesive, which affects the accuracy in fixing a joint portion to some degree. In terms of this, an improvement has been demanded.

It is desirable to provide a fixing structure and an optical device that make it possible to appropriately suppress the occurrence of a positional shift of an object due to a change in volume of an adhesive.

A fixing structure according to one embodiment of the present disclosure is a fixing structure in which a first object and a second object are fixed to each other with an adhesive. The first object has a first adhesive face in contact with the adhesive. The second object has a second adhesive face that faces the first adhesive face, and an extended face that is provided on at least a part of an entire periphery surrounding the adhesive about an axis perpendicular to the second adhesive face and extends in a direction parallel to the axis perpendicular to the second adhesive face. The adhesive is in contact with the second adhesive face of the second object, whereas not in contact with the extended face.

An optical device according to one embodiment of the present disclosure includes an optical component having a first face, and a holding member having a second face that faces the first face. The holding member is fixed to the optical component with an adhesive. The optical component is in contact with the adhesive at at least a part of the first face. The part of the first face is a first adhesive face. The holding member has a recess in the second face. The recess opens toward the first adhesive face and has a bottom face and a side face extending from the bottom face toward the optical component. The bottom face is in contact with the adhesive and is a second adhesive face. The side face is not in contact with the adhesive.

### BRIEF DESCRIPTION OF DRAWINGS

FIG. 1 is a schematic diagram schematically illustrating an appearance of an optical device to which a fixing structure according to one embodiment of the present disclosure is applied.

FIG. 2 is a schematic diagram illustrating a procedure for fixing an optical component and a holding member of the optical device according to the embodiment to each other.

FIG. 3 is a schematic diagram schematically illustrating a state of the optical device according to the embodiment described above at and near a joint portion fixed with an adhesive before and after the expansion of the adhesive.

FIG. 4 is a schematic diagram schematically illustrating a state at and near the joint portion fixed with an adhesive before and after the expansion of the adhesive according to an comparative example with respect to the embodiment.

FIG. 5 is an explanatory diagram illustrating a relation between an interval X between objects and a thixotropic ratio Y of the adhesive before curing.

### MODES FOR CARRYING OUT THE INVENTION

In the following, some embodiments of the present disclosure are described in detail with reference to the drawings. The embodiments described below are specific examples of the present disclosure and are not intended to limit the technology of the present disclosure to the following specific aspects. Further, the arrangement, dimensions, and dimension ratios of components in the following embodiments are not limited to examples illustrated in each of the drawings.

The description is made in the following order.
1. Schematic Configuration of Optical Device
2. Procedure for Assembling Optical Device
3. Workings and Effects
4. Conclusion

### 1. Schematic Configuration of Optical Device

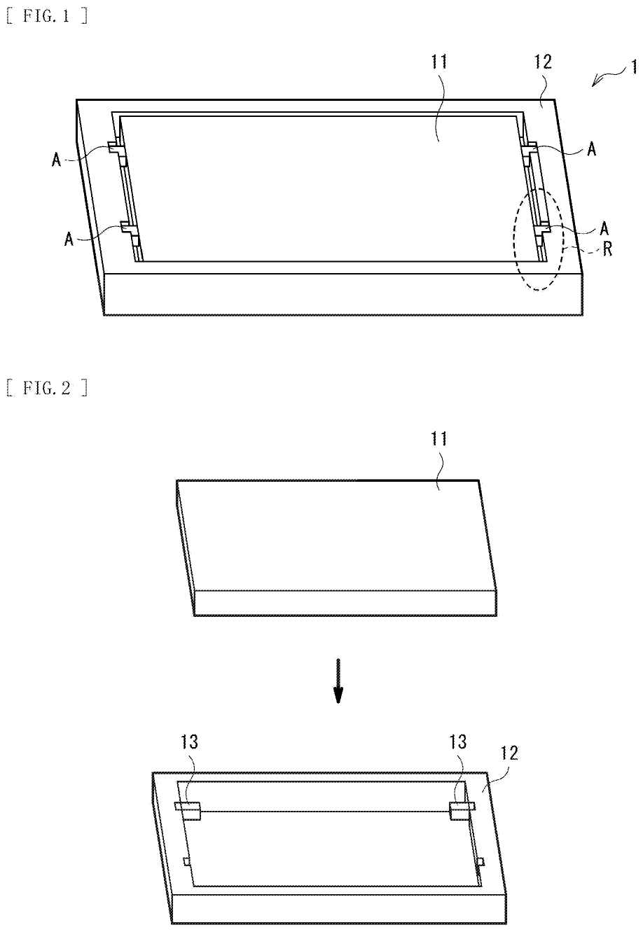

FIG. 1 is a schematic diagram schematically illustrating an appearance of an optical device 1 to which a fixing structure according to an embodiment of the present disclosure is applied.

In the present embodiment, the optical device 1 includes an optical glass component 11 and a frame 12 fixed to each other with an adhesive A. The optical glass component 11 is an optical component. The frame 12 is a holding member. Examples applicable as the optical glass component 11 may include a lens, a polarization plate, and a half mirror. The frame 12 may include a metal material such as aluminum or a reinforced plastic material, for example. The material of the frame 12 may be selected as appropriate depending on the rigidity of the frame 12 required. The optical glass component 11 corresponds to a “first object” according to the present embodiment, and the frame 12 corresponds to a “second object” according to the present embodiment.

In a case where the optical glass component 11 of the optical device 1 is a lens, for example, accuracy in positioning the optical glass component 11 in a direction perpendicular to a surface of the optical glass component 11, i.e., in an optical axis direction is an essential issue. In the present embodiment, accuracy of several hundred nanometers (nm) order to micrometer (μm) order in the optical axis direction is required in positioning the optical glass component 11.

To achieve such high positioning accuracy, a fixing structure described below is employed in the present embodiment. In the following description, out of directions perpendicular to the surface of the optical glass component 11 (hereinafter referred as “vertical directions” as appropriate), the direction in which the surface of the optical glass component 11 faces, i.e., an upward direction in FIG. 1 is referred to as “upward”, and the direction opposite to the upward direction is referred to as “downward”. Further, out of directions perpendicular to an inner face 12a of the frame 12 (i.e., directions parallel to the surface of the optical glass component 11, hereinafter referred to as “horizontal directions”), the direction toward the inside of the frame 12 is referred to as “inward”, and the direction opposite to the inward direction and toward the outside of the frame 12 is referred to as “outward”.

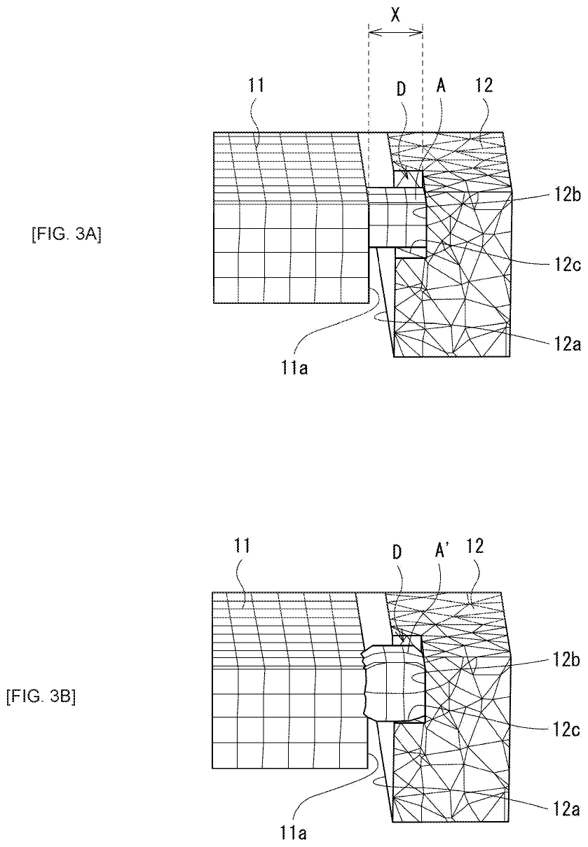

FIG. 3 is a schematic diagram schematically illustrating a state of the optical device 1 according to the present embodiment at and near a joint portion fixed with the adhesive A before the expansion of the adhesive A (a) and after the expansion of the adhesive A (b). In FIG. 3, an area R in FIG. 1 is illustrated in an enlarged manner. The fixing structure according to the present embodiment is described with reference to FIG. 3(a) for convenience.

In the present embodiment, the optical glass component 11, which is the first object, and the frame 12, which is the second object, are fixed to each other with the adhesive A. The optical glass component 11 has an end face 11a facing the inner face 12a of the frame 12. The adhesive A is in contact with a part of the end face 11a. Meanwhile, the frame 12 has a recess D in a part of the inner face 12a. The recess D opens toward the end face 11a of the optical glass component 11. The recess D opens inward and upward. In other words, the recess D is closed in the directions other than the inward direction and the upward direction, has a bottom face 12b parallel to the end face 11a of the optical glass component 11, and has a side face 12c perpendicular to the bottom face 12b. The adhesive A is held between the end face 11a of the optical glass component 11 and the bottom face 12b of the recess D of the frame 12, and is in contact with a part of the bottom face 12b of the recess D.

The end face 11a of the optical glass component 11 corresponds to a “fist face” according to the present embodiment. The inner face 12a of the frame 12 corresponds to a “second face” according to the present embodiment. The part of the end face 11a of the optical glass component 11 in contact with the adhesive A corresponds to a “first adhesive face” of the present embodiment. The part of the inner face 12a of the frame 12, specifically, the bottom face 12b of the recess Din contact with the adhesive A corresponds to a “second adhesive face” according to the present embodiment. Further, the side face 12c of the recess D is a part of an entire periphery surrounding the adhesive A about an axis perpendicular to the bottom face 12b. In specific, the side face 12c is provided below the adhesive A and extends in the direction parallel to the axis perpendicular to the bottom face 12b. The side face 12c corresponds to an “extended face” according to the present embodiment.

Here, the adhesive A is in contact with the part of the end face 11a of the optical glass component 11 and the part of the bottom face 12b of the recess D of the frame 12, whereas not in contact with the side face 12c of the recess D. Thus, the adhesive A is separate from the side face 12c.

Out of the side faces surrounding the adhesive A about the axis perpendicular to the bottom face 12b of the recess D, the faces provided on a side of the adhesive A may be in contact with the adhesive A or may not be in contact with the adhesive A.

### 2. Procedure for Assembling Optical Device

FIG. 2 is a schematic diagram illustrating a procedure for fixing the optical glass component and the frame 12 of the optical device 1 according to the present embodiment to each other.

In a state before the optical device 1 is assembled, the frame 12 includes an appropriate number of abutting joints 13. When the optical glass component 11 and the frame 12 are fixed to each other, the optical glass component 11 may be placed on the abutting joints 13. The positional alignment of the optical glass component 11 is performed while the optical glass component 11 is placed on the abutting joints 13, and the position of the optical glass component 11 in the vertical directions is thereby determined.

While the optical glass component 11 is placed on the abutting joints 13, a slight gap is formed between the end face 11a of the optical glass component 11 and the inner face 12a of the frame 12. The presence of the gap allows the position of the optical glass component 11 to be slightly shifted in the horizontal directions to achieve the positional adjustment with respect to the frame 12 during curing of the adhesive A. Here, the recess D defines a target region to which the adhesive A is to be applied. If the adhesive A is applied in an amount more than necessary, the side face 12c of the recess D serves as a receiver that helps prevent an excess portion of the adhesive A from flowing from the recess D and running downward the inner face 12a of the frame 12.

The adhesive A is an UV curable adhesive. Examples applicable as the adhesive A may include an acrylic-based adhesive, a modified acrylate-based adhesive, a silicone-based adhesive, a modified silicone-based adhesive, and an urethan-based adhesive. Advantages of using the modified acrylate-based adhesive lie in that the adhesive A is curable by UV light irradiation for a short time such as several seconds, and that the position of the optical glass component 11 is easily adjusted during curing of the adhesive A. In place of the UV curable adhesive, a two-liquid curable epoxy-based adhesive and a temperature curable adhesive may be employed.

After the optical glass component 11 is placed on the abutting joints 13, the adhesive A is applied so as to be in contact with both of a part of the end face 11a of the optical glass component 11 and a part of the bottom face 12b of the recess D of the frame 12 facing each other. Here, the adhesive A is not in contact with the side face 12c of the recess D and kept separate from the side face 12c.

As to be described in more detail later, because the adhesive A is kept separate from the side face 12c of the recess D, a relation represented by the following expression (1) is satisfied between X and Y:

2X≤Y (1)

where X represents an interval between the end face 11a of the optical glass component 11 and the bottom face 12b of the recess D of the frame 12, and Y represents the thixotropic ratio Y of the adhesive A before curing.

### 3. Workings and Effects

When the optical device including the optical component fixed with the adhesive is exposed in a high-temperature high-humidity environment, a thermal shock, or a temperature cycle condition, the positional shift of the optical component may occur due to a change in volume of the adhesive, e.g., the expansion or contraction of the adhesive, and a decrease in adhesive strength and a decrease in shock resistance may occur due to changes in mechanical property and stress distribution of the adhesive.

As a fixing method for an application, such as an optical device, that requires relatively high accuracy (e.g., accuracy of 1 μm order) in fixing a joint portion with an adhesive, PTL 1 described above discloses addition of an inorganic filler having a low thermal expansion rate to an adhesive. In the technique described in PTL 1, an inorganic filler having an average particle size of 1 to 20 μm is added to an adhesive to suppress a change in volume of the adhesive in a high-temperature high-humidity environment or a temperature cycle condition. The technique described in PTL 1 is expected to improve peeling resistance; however, it is difficult for the technique described in PTL 1 to completely eliminate the change in volume of the adhesive, which affects the accuracy in fixing the joint portion to some degree. In particular, there is room for a further improvement in terms of the difficulty in completely eliminating the positional shift of the optical component. In the high-temperature high-humidity environment, the adhesive is swollen with moisture, resulting in an increase in the volume of the adhesive by several % to several ten %. Thus, the high-temperature high-humidity environment may affect the positional shift to a larger degree.

Meanwhile, Japanese Unexamined Patent Application Publication No. 2016-020951 discloses forming a frame having an abutting face to which an optical component is fixed, and forming a through hole having an opening in the abutting face. When the optical component is fixed to the frame, an adhesive is applied to a joint portion between the optical component and the frame via the through hole while the optical component is in contact with the abutting face and the positional alignment of the optical component in a thrust direction is performed. The technique described in Unexamined Patent Application Publication No. 2016-020951 suppresses the occurrence of a distortion of the optical component fixed on the abutting face during the contraction of the adhesive, but is not able to address problems caused during the expansion of the adhesive. One reason for this is that the adhesive swells in a high-temperature high-humidity environment, and thus a stress is applied to the optical component in a direction in which the optical component is separated from the abutting face.

In contrast, the present embodiment provides a fixing structure in which two objects are joined to each other with an adhesive, and the adhesive is in contact with the faces of the two objects facing each other, whereas not contact with the other faces of the two objects. The structure in which the other faces of the two objects are not in contact with the adhesive is achieved by applying the adhesive while the other faces than the faces facing each other are separate from the adhesive upon joining the two objects, and curing the adhesive while the state is maintained.

FIG. 3 is a schematic diagram schematically illustrating the state of the optical device 1 according to the present embodiment at and near the joint portion fixed with an adhesive A before the expansion of the adhesive A (a) and after the expansion of the adhesive A (b).

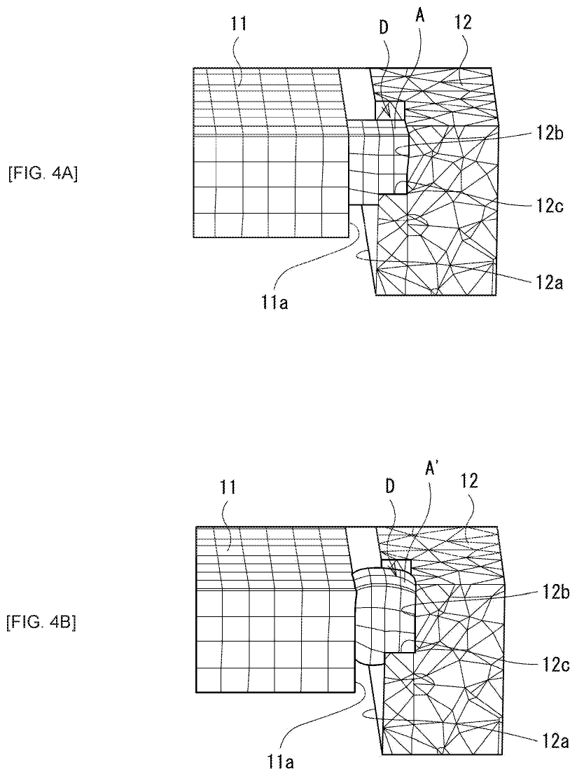

FIG. 4 is a schematic diagram schematically illustrating the state at and near the joint portion fixed with the adhesive A before the expansion of the adhesive A (a) and after the expansion of the adhesive A (b) according to the comparative example.

In general, the adhesive A has a viscosity determined by adjusting the composition of the adhesive A taking into consideration the workability in applying the adhesive A. Thus, after being applied, the adhesive A is prevented from immediately flowing from the recess D and running downward the inner face 12a of the frame 12. However, owing to the provision of the recess D and the side face 12c of the recess D serving as the receiver that receives an excess portion of the adhesive A, the adhesive A is prevented from running downward before the adhesive A is completely cured. In the comparative example illustrated in FIG. 4, the adhesive A is in contact with three or more faces including the end face 11a of the optical glass component 11, the bottom face 12b of the recess D of the frame 12, and the side face 12c of the recess D of the frame 12.

In a case where the optical device 1 in this condition is exposed in a high-temperature high-humidity environment, the adhesive A may cause a change in volume (the expansion in this case), resulting in an upward positional shift of the optical glass component 11. In FIG. 4, the adhesive after the expansion is, in particular, denoted by a reference A′ (the same applies to FIG. 3). This positional shift is caused by an increase in the volume of the adhesive A due to the moisture entering the adhesive A and diffusing therein. The adhesive A deforms to release the stress caused by the expansion. However, in the comparative example, a deformation in the horizontal directions perpendicular to the inner face 12a of the frame 12 is limited by the optical glass component 11 and the frame 12, and thus the adhesive A is forced to deform in the vertical directions. Further, a downward deformation is limited by the side face 12c or the receiver of the recess D. As a result, the adhesive A is urged to deform upward. Accordingly, the optical glass component 11 is moved upward by being pulled by the adhesive A, resulting in an upward positional shift. The positional shift of the optical glass component 11 in the vertical directions may cause a shift of a focus position and the generation of a light path difference between incident light and reflected light.

In contrast, in a case where the optical device is exposed in a low-temperature environment, for example, the adhesive A contracts. In this case, the adhesive A comes into contact with the side face 12c of the recess D, and the upward deformation of the adhesive A is limited whereas the downward deformation is not limited. The adhesive A thus deforms so as to contract downward. Accordingly, the optical glass component 11 is moved downward by being pulled by the adhesive A, resulting in a downward positional shift. The downward shift of the optical glass component 11 is limited by the abutting joints 13 in the comparative example; however, any irregularity or foreign matter on the surfaces of the abutting joints 13 may cause the optical glass component 11 to rotate about the irregularity or a contact with the tip of the foreign matter, resulting in a positional shift.

To address this concern, in the present embodiment, as illustrated in FIG. 3, the adhesive A is in contact with the bottom face 12b of the recess D of the frame 12, whereas not in contact with the side face 12c. Accordingly, even if the adhesive A causes a change in volume, the deformation of the adhesive A is generated to the same degree in the vertical directions (i.e., the deformation of the adhesive A is released to the same degree in the vertical directions) without being limited by the side face 12c of the recess D. This makes it possible to suppress the occurrence of a positional shift of the optical glass component 11, in particular, the occurrence of a positional shift of the optical glass component 11 in the vertical directions in which positional accuracy is required.

This is not limited to the case where the adhesive A expands in a high-temperature high-humidity environment, for example, and also applies to the case where the adhesive A contracts in a low-temperature environment, for example.

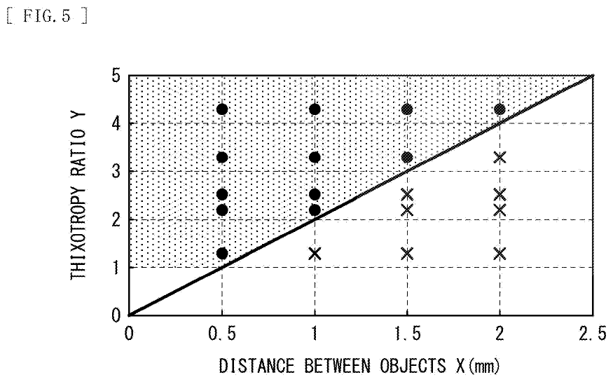

FIG. 5 is an explanatory diagram illustrating a relation between X and Y where X represents an interval between the end face 11a of the optical glass component 11 and the bottom face 12b of the recess D of the frame 12, and Y represents the thixotropic ratio of the adhesive A before curing. The interval X is indicated by a horizontal axis, and the thixotropic ratio Y is indicated by a vertical axis.

The thixotropic ratio Y may be determined by calculating a ratio between a viscosity of the adhesive A at the time of high-speed rotation (e.g., 10 rpm) at a temperature of 25° C. and a viscosity of the adhesive A at the time of low-speed rotation (e.g., 1 rpm) by means of a rotation viscosimeter. In general, an adhesive with a high thixotropic property secures fluidity when being applied while maintaining its shape after being applied, and is thus unlikely to flow downward. It is therefore easy to keep the adhesive A separate from the side face 12c of the recess D.

In FIG. 5, a circle (∘) represents a case where the adhesive A was favorably held between the end face 11a of the optical glass component 11 and the bottom face 12b of the recess D of the frame 12 and kept separate from the side face 12c of the recess D after being applied, and a cross (x) represents a case where the adhesive A flowed downward and came into contact with faces (e.g., the side face 12c of the recess D) other than the end face 11a and the bottom face 12b facing each other.

As apparent from FIG. 5, in a case where the relation represented by the expression (1) described above is satisfied between the interval X and the thixotropic ratio Y, it is possible to favorably hold the adhesive A between the end face 11a of the optical glass component 11 and the bottom face 12b of the recess D of the frame 12 and keep the adhesive A separate from the side face 12c of the recess D.

In the present embodiment, the end face 11a of the optical glass component 11 and the bottom face 12b of the recess D of the frame 12 are parallel to each other, and thus the adhesive faces to which the adhesive A is applied are parallel to each other. However, in a case where the adhesive faces are inclined with respect to each other, the relation represented by the expression (1) described above is satisfied at the narrowest interval between the adhesive faces, and thus a same effect may be obtained.

According to the present embodiment described above, the optical glass component 11 and the frame 12 are joined to each other with the adhesive A in contact with the adhesive faces of the optical glass component 11 and the frame 12, while the side face 12c of the recess D of the frame 12 is not contact with the adhesive A. This suppresses the occurrence of an unbalanced deformation of the adhesive A even if the adhesive A causes a change in volume, e.g., a deformation such as an expansion or a contraction, and suppresses the occurrence of a positional shift of the optical glass component 11.

Owing to the provision of the side face 12c of the recess D, an excess portion of the adhesive A flowing downward before the adhesive A is completely cured is received by the side face 12c. This prevents the adhesive A from coming into contact with the other faces (e.g., the inner face 12a of the frame 12).

Further, owing to the relation, 2X≤Y satisfied between the interval X and the thixotropic ratio Y, it is possible to favorably hold the adhesive A between the end face 11a of the optical glass component 11 and the bottom face 12b of the recess D of the frame 12 upon joining, and to favorably maintain the state in which the adhesive A is not contact with the side face 12c of the recess D.

### 4. Conclusion

As described above, some embodiments of the present disclosure have been described in detail with reference to the drawings. According to the embodiments of the present disclosure, it is possible to suppress the occurrence of an unbalanced deformation of an adhesive and suppress the occurrence of a positional shift of an object even if the adhesive causes a change in volume.

The technology of the present disclosure is not limited to the specific embodiments described above and may be modified in a variety of ways. In addition, modification examples may be combined to each other.

Further, not all of the configurations and operations described in each of the embodiments are necessarily essential. For example, among the components in each embodiment, components not recited in the independent claim describing the broadest concept of the present disclosure should be construed as optional components.

The terms used throughout the specification and the appended claims should be interpreted as “non-limiting” terms. For example, the term “including” or “included” should be interpreted as “not limited to the aspects stated as being included”, and the term “having” should be interpreted as “not limited to the aspects stated as having”.

The terms used herein are for the convenience of description only and includes terms not intended to limit the configuration, operation, or the like. For example, the terms such as “right”, “left”, “up”, “down” and the like refer only to directions on the drawings to which reference is made. Further, the terms such as “inner” and “outer” refer to a direction towards the center of an element of interest and a direction away from the center of an element of interest, respectively. The same applies to terms similar to or equivalent to these terms.

The technology of the present disclosure may have configurations described below. According to the technology of the present disclosure having the configurations described below, it is possible to suppress the occurrence of an unbalanced deformation of the adhesive when the adhesive causes a change in volume, and suppress the occurrence of a positional shift of the object to be joined. Effects of the technology of the present disclosure are not necessarily limited to these effects and may be any effects described herein.
(1) A fixing structure including
   a first object and a second object that are fixed to each other with an adhesive, in which
   the first object has a first adhesive face in contact with the adhesive,
   the second object has a second adhesive face that faces the first adhesive face, and an extended face that is provided on at least a part of an entire periphery surrounding the adhesive about an axis perpendicular to the second adhesive face and extends in a direction parallel to the axis perpendicular to the second adhesive face, and
   the adhesive is in contact with the second adhesive face of the second object, whereas not in contact with the extended face.
(2) The fixing structure according to (1) described above, in which
   in a case where the objects are disposed at an interval X and the adhesive has a thixotropic ratio Y before being cured, the interval X and the thixotropic ratio Y satisfy a relation, 2X≤Y.
(3) The fixing structure according to (1) or (2) described above, in which
   the first object is an optical glass component,
   the second object is a frame configured to hold the optical glass component, and
   the optical glass component is fixed to the frame with the adhesive.
(4) The fixing structure according to any one of (1) to (3) described above, in which
   the extended face is directed in a direction in which accuracy regarding a position of the first object after fixing is required.
(5) The fixing structure according to any one of (1) to (4) described above, in which the adhesive is an UV curable adhesive.
(6) The fixing structure according to (5) described above, in which the adhesive is an acrylic-based adhesive, a modified acrylate-based adhesive, a silicone-based adhesive, a modified silicone-based adhesive, or an urethan-based adhesive.
(7) An optical device including:
   an optical component having a first face; and
   a holding member having a second face that faces the first face, the holding member being fixed to the optical component with an adhesive, in which
   the adhesive is in contact with at least a part of the first face of the optical component, the part of the first face being a first adhesive face, and
   the second face of the holding member has a recess that opens toward the first adhesive face, the recess having a bottom face in contact with the adhesive, the bottom face of the recess being a second adhesive face, and
   a side face extending from the bottom face toward the optical component is not in contact with the adhesive.

This application claims the benefit of Japanese Priority Patent Application JP2020-194725 filed with the Japan Patent Office on Nov. 24, 2020, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A fixing structure comprising
a first object and a second object that are fixed to each other with an adhesive, wherein
the first object has a first adhesive face in contact with the adhesive,
the second object has a second adhesive face that faces the first adhesive face, and an extended face that is provided on at least a part of an entire periphery surrounding the adhesive about an axis perpendicular to the second adhesive face and extends in a direction parallel to the axis perpendicular to the second adhesive face, and
the adhesive is in contact with the second adhesive face of the second object, whereas not in contact with the extended face.

2. The fixing structure according to claim 1, wherein,
in a case where the objects are disposed at an interval X and the adhesive has a thixotropic ratio Y before being cured, the interval X and the thixotropic ratio Y satisfy a relation, 2X≤Y.

3. The fixing structure according to claim 1, wherein
the first object comprises an optical glass component,
the second object comprises a frame configured to hold the optical glass component, and
the optical glass component is fixed to the frame with the adhesive.

4. The fixing structure according to claim 1, wherein
the extended face is directed in a direction in which accuracy regarding a position of the first object after fixing is required.

5. The fixing structure according to claim 1, wherein the adhesive comprises an UV curable adhesive.

6. The fixing structure according to claim 5, wherein the adhesive comprises an acrylic-based adhesive, a modified acrylate-based adhesive, a silicone-based adhesive, a modified silicone-based adhesive, or an urethan-based adhesive.

7. An optical device comprising:
an optical component having a first face; and
a holding member having a second face that faces the first face, the holding member being fixed to the optical component with an adhesive, wherein
the optical component is in contact with the adhesive at at least a part of the first face, the part of the first face comprising a first adhesive face, and
the holding member has a recess in the second face, the recess opening toward the first adhesive face and having a bottom face and a side face extending from the bottom face toward the optical component, the bottom face being in contact with the adhesive and comprising a second adhesive face, the side face being not in contact with the adhesive.
